(19) United States
(12) Patent Application Publication
(10) Pub. No.: US 2026/0322026 A1
(43) Pub. Date: Oct. 15, 2026

(54) RETAINING FRAME FOR A CONNECTOR HOUSING FOR AN INDUSTRIAL CONNECTOR

(71) Applicant: HARTING ELECTRIC STIFTUNG & CO. KG, Espelkamp (DE)

(72) Inventors: Sebastian GRIEPENSTROH, Lübbecke (DE); Martin SCHMIDT, Lübbecke (DE)

(21) Appl. No.: 19/485,994

(22) PCT Filed: May 14, 2024
(86) PCT No.: PCT/DE2024/100435

§ 371 Date: Nov. 19, 2025

(30) Foreign Application Priority Data
May 24, 2023 (DE) 10 2023 113 560.0

(51) Int. Cl. H01R 13/514; H01R 13/6582; H01R 13/6591

(52) U.S. Cl. CPC H01R 13/514; H01R 13/6582; H01R 13/6591

(57) ABSTRACT

A retaining frame for a connector housing of an industrial connector and for receiving identical and/or different connector modules is provided, wherein the retaining frame has latching means or a latching device with which it can be latched in the connector housing or wherein the retaining frame is at least partially enclosed by the material of the connector housing and is thus an integral component of the connector housing. A system comprising or consisting of such a retaining frame and at least two connector modules that are received in the retaining frame is also provided.

### BACKGROUND

### Technical Field

The disclosure relates to a retaining frame for a connector housing of an industrial connector. The disclosure further relates to a system comprising or consisting of a connector housing, a retaining frame and at least two connector modules received in the retaining frame.

Such retaining frames are used to receive and retain connector modules used in modular industrial connectors.

The connector modules are required as components of a modular connector system in order to be able to flexibly adapt a connector, in particular a heavy-duty industrial connector, to specific requirements regarding signal and energy transmission, e.g., between two electrical devices. For this purpose, connector modules are usually inserted into corresponding retaining frames, which are sometimes also referred to as hinge frames, module frames, or modular frames. The retaining frames thus serve to receive several connector modules of the same type and/or different types and to secure them to a surface and/or a device wall and/or in a connector housing or the like.

The connector modules usually each have a substantially cuboid insulating body or a cuboid housing. These insulating bodies or housings can, for example, serve as contact carriers and can receive and fix contacts of various types. The function of a connector formed in this way is therefore very flexible. For example, pneumatic modules, optical modules, modules for transmitting electrical energy and/or electrical analog and/or digital signals can be received in the respective insulating body or housing and thus can be used in the modular connector system. Connector modules are also increasingly taking on measurement and data-related tasks.

In some instances, retaining frames consisting of two frame halves connected to each other in an articulated manner are used. The connector modules are provided with retaining means or devices projecting from the narrow sides, which are approximately rectangular or cuboid in shape. Recesses are provided in the side parts of the frame halves as openings closed on all sides, into which the retaining means or devices engage when the connector modules are inserted into the retaining frame. To insert the connector modules, the retaining frame is unfolded, i.e., opened, wherein the frame halves are unfolded about the joints only to the extent that the connector modules can be inserted. The frame halves are then folded together, i.e., the retaining frame is closed, wherein the retaining means or devices engage in the recesses and ensure that the connector modules are held securely and form-fittingly in the retaining frame.

The modular industrial connectors described above offer a high degree of flexibility and can be configured for a wide range of applications by installing connector modules with different functions in a common retaining frame. However, the number of connector module slots in a retaining frame is limited. This limits the flexibility of an industrial connector.

### Description of the Related Art

DE 197 07120 C1 shows a retaining frame consisting of two halves connected to each other in an articulated manner so that a connector module can be easily inserted into a module slot when the frame is open and is held securely in its module slot when the halves are closed. The retaining frame equipped with several connector modules is then screwed into a connector housing. Such a retaining frame is particularly stable and absorbs the plugging and pulling forces of the connector well. However, when the retaining frame is inserted into the connector housing beforehand, the frame halves may accidentally open, which makes assembly more difficult. In addition, a two-part retaining frame is quite expensive to manufacture.

DE 10 2017 124 632 A1 shows a retaining frame for an industrial connector for holding identical and/or different connector modules, wherein the retaining frame substantially consists of a three-dimensionally bent wire frame.

Such a retaining frame can be manufactured inexpensively. However, the assembly of a modular industrial connector with such a retaining frame is more difficult because the delicate retaining frame does not hold the connector modules reliably in position, making it difficult to screw the retaining frame into the connector housing.

The German Patent and Trade Mark Office has researched the following prior art in the priority application for the present application: DE 197 07 120 C1, DE 10 2017 124 632 A1, DE 10 2018 115 371 A1, EP 2 537 212 B1, EP 2 930 794 A1 and WO 2021/254822 A1.

### BRIEF SUMMARY

Embodiments of the present invention provide a retaining frame that enables simple assembly of a modular industrial connector and is also inexpensive to manufacture.

The retaining frame according to embodiments of the present invention is intended for a connector housing of an industrial connector. The retaining frame is used to hold identical and/or different connector modules. The retaining frame has locking means or devices with which it can be locked in the connector housing. Alternatively, the retaining frame is enclosed at least in some areas by material of the connector housing and is thus an integral part of the connector housing.

The latter means that the retaining frame is, for example, directly injection molded from the material of the connector housing. In this case, the housing would be made of plastic. A plastic housing with an integrated retaining frame would enable a particularly lightweight modular industrial connector, which is advantageous in various applications.

In some instances, the connector modules can be reversibly locked into the retaining frame. This allows incorrectly inserted connector modules to be removed and repositioned correctly.

The retaining frame has at least two module slots for receiving a connector module. Preferably, each module slot has two opposing locking tabs that interact with retaining means or devices molded onto the connector modules in such a way that the respective connector module is locked into the respective module slot and is thus held in the retaining frame.

The retaining frame preferably has a PE connection. The PE connection enables protective earthing of the retaining frame or a connector.

The PE connection is preferably designed as a screw connection or a crimp connection or as a conductor welded to the retaining frame.

It is advantageous if the retaining frame is made of a metal material, such as, for example, spring sheet metal. In this case, the retaining frame can also serve for protective conductor transfer in a plug connection, as presented in more detail below with reference to an exemplary embodiment.

For this purpose, the retaining frame may have at least one transfer lug which is intended for electrical contact with a retaining frame of a mating connector.

Advantageously, the transfer lug extends in a plug-in direction. Such positioning of the transfer lug is particularly space-saving and easy to provide on the retaining frame.

In a particularly advantageous variant of the invention, the retaining frame has two transfer lugs arranged diagonally opposite each other on the retaining frame. This ensures reliable ground transfer even if the connectors are not brought together absolutely parallel.

Embodiments of the present invention also relate to a system comprising or consisting of a connector housing, a retaining frame designed as described above, and at least two connector modules which are received in the retaining frame.

Advantageously, the system has at least one connector module which is formed from two independent functional units fixed to one another.

A functional unit forms an independent component. The functional unit can function independently, i.e., without another functional unit connected to it. A functional unit does not become technically usable only by joining two or more functional units to form a connector module.

Preferably, a functional unit has at least one contact element and/or one sensor. The contact element may, for example, be an electrical contact element for transmitting current or signals. The contact element may also be an optical contact element to which, for example, an optical waveguide is connected. A functional unit may have several contact elements, in particular several different contact elements. For example, electrical and optical contact elements may be mixed together. The sensor may be, for example, a current sensor that monitors an adjacent contact element, for example arranged in an adjacent functional unit. However, temperature sensors, optical sensors, in particular scattered light sensors, or other sensors may also be provided. A functional unit may also contain several sensors, in particular also different sensors. A functional unit may also contain a sensor or several sensors and, at the same time, a contact element or several contact elements.

The functional units of a connector module can operate completely independently of one another. However, the functional units may also experience a synergy effect when they are joined together, in particular when sensors of one functional unit are combined with contact elements of another functional unit.

### BRIEF DESCRIPTION OF THE SEVERAL VIEWS OF THE DRAWINGS

Exemplary embodiments of the invention are shown in the drawings and explained in more detail below.

FIG. 1 shows a perspective view of a connector housing of an industrial connector,

FIG. 2 shows a perspective view of a mounting frame equipped with various connector modules,

FIG. 3 shows a perspective view of a retaining frame according to the invention,

FIG. 4 shows another perspective view of a retaining frame according to the invention, and

FIG. 5 shows a perspective view of an alternative connector housing of an industrial connector with integrated retaining frames.

The figures may contain partially simplified, schematic representations. In some cases, identical reference signs are used for elements that are the same but may not be identical. Different views of the same elements may be scaled differently. Directional indications such as “left,” “right,” “top,” and “bottom” are to be understood with reference to the respective figure and may vary in the individual representations relative to the object depicted.

### DETAILED DESCRIPTION

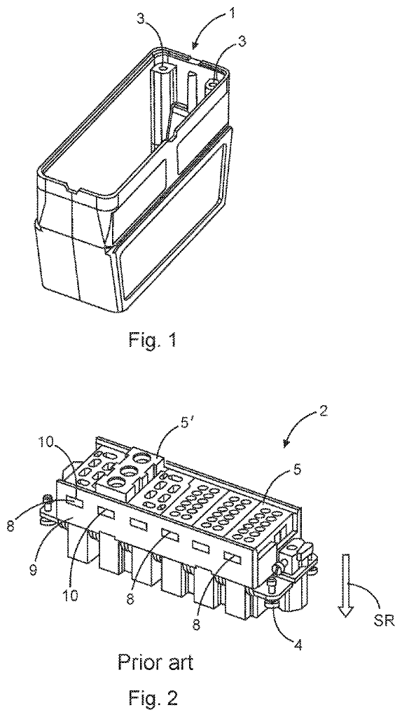

FIG. 1 shows a connector housing 1 of an industrial connector. The connector housing 1 is usually made of a metal material and may be manufactured in particular by a zinc die-casting process. Such a connector housing is robust and has good electromagnetic shielding properties and is therefore particularly suitable for harsh industrial environments. Alternatively, the connector housing 1 can also be made of plastic, in particular of the same plastic as the connector modules 5 according to embodiments of the invention. In this case, screw sleeves would be provided instead of threaded holes 3. In this case, an industrial connector would be easier to manufacture than a comparable connector with a metal housing.

FIG. 2 shows a retaining frame 2 equipped with various connector modules 5, which is known from the prior art. The retaining frame 2 has a frame-like shape and has screws 4 at each of its corners. The connector housing 1 has an approximately rectangular cross-section and has corresponding threaded holes 3 inside the housing in its corner areas. The retaining frame 2 can be fastened in the connector housing 1 via the screws 4 in conjunction with the associated threaded holes 3 of the connector housing 1.

The retaining frame 2 consists of two frame halves 9 that are connected to each other in an articulated manner. Recesses 10 are provided in each of the frame halves 9 of the retaining frame 2, into which recesses the retaining means or devices 8 of the connector module 5 or the connector modules 5 engage when inserted. When the frame halves 9 are folded together, the retaining means or devices 8 engage completely in the recesses 10, thereby establishing a form-fitting hold of the connector module 5 or the connector modules 5 in the retaining frame 2.

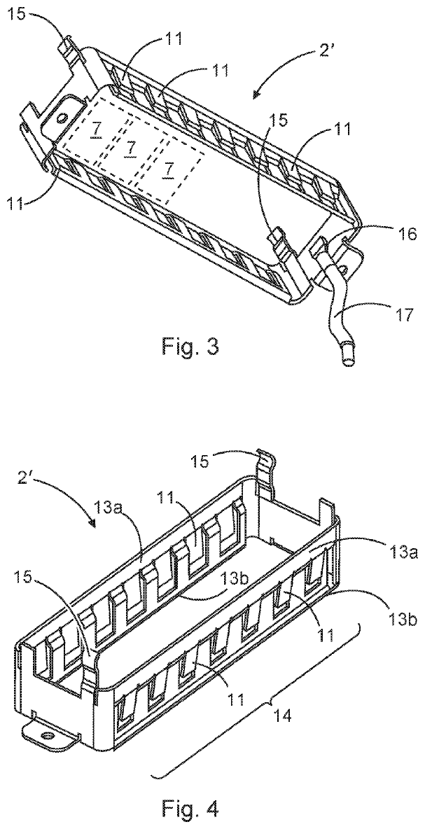

FIGS. 3 and 4 show a perspective view of a retaining frame 2′ according to an example embodiment of the invention. The retaining frame 2′ has a substantially rectangular cross-section. The retaining frame 2′ has lateral frame walls 14, each of which is delimited at the top and bottom by frame end portions 13a, 13b.

The retaining frame 2′ has several module slots 7, of which only three are labeled in FIG. 3 as examples by way of dotted boxes. The retaining frame 2, 2′ can receive one plug-in connector module 5 in each module slot 7.

Each module slot 7 of the retaining frame 2′ has two opposing locking tabs 11. The locking tabs 11 are arranged between two webs pointing substantially in a plug-in direction, which abut at their ends against the frame end portions 13a, 13b. The webs are also pulled slightly into the interior of the retaining frame 2′ or extend into the interior of the retaining frame 2′ in some regions.

The locking tabs 11 interact with the retaining means or devices 8 integrally molded on the connector modules 5, in such a way that the respective connector module 5 locks into the respective module slot 7 and is thereby held in the retaining frame 2′. This function is described in more detail below.

The webs run parallel to each other. The distance between the webs corresponds to the width of the retaining means or devices 8 of the connector module 5. The retaining means or devices 8 of the connector module 5 are pressed against the frame end portion 13b by the locking tabs 11 arranged between the webs. This holds or secures the connector modules 5 in the retaining frame 2′. The connector modules 5 can be removed from the retaining frame 2′ by pressing back the locking tabs 11 manually or using a tool.

The retaining frame 2′ has a PE connection 16 to which a PE conductor 17 is connected. The PE conductor 17 may be part of a multi-core cable (not shown) which is connected to the connector.

The retaining frame 2′ has transfer lugs 15 pointing in the plug-in direction and arranged diagonally to each other. The transfer lugs 15 are located at two corner regions of the retaining frame 2′ and are bent in an S-shape. When plugged in, the transfer lugs 15 of a first retaining frame 2′ engage with a second retaining frame 2′, so that electrical contact is established between the retaining frames 2′. This enables PE transfer or protective conductor transfer of the plug connection.

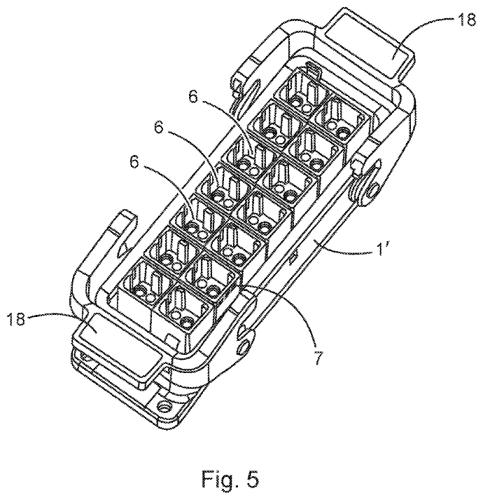

FIG. 5 shows an industrial connector with an add-on housing 1′. Locking brackets 18 are mounted on suitable pins on the narrow sides of the connector housing 1′ so that said brackets can be pivoted. A retaining frame 2′ is arranged inside the connector housing 1′. The individual module slots 7 of the retaining frame 2′ are equipped with connector modules 5, each of which is formed from two individual functional units 6.

Even if different aspects or features of the embodiments of the invention are shown in combination in the figures, it is apparent to a person of ordinary skill in the relevant art—unless otherwise specified—that the combinations shown and discussed are not the only ones possible. In particular, corresponding units or feature complexes from different exemplary embodiments can be exchanged with one another. In other words, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A retaining frame for a connector housing of an industrial connector and for receiving identical and/or different connector modules, the retaining frame comprising:
a locking device with which the retaining frame can be locked in the connector housing, or
wherein the retaining frame is at least partially enclosed by material of the connector housing and is therefore an integral part of the connector housing.

2. The retaining frame as claimed in claim 1, wherein the retaining frame is configured such that the connector modules can be reversibly locked into the retaining frame.

3. The retaining frame as claimed in claim 1, wherein the retaining frame has at least two module slots for receiving a respective connector module, and
wherein each module slot has two opposing locking tabs which interact with retaining devices integrally molded on the connector modules, in such a way that the respective connector module is locked in the respective module slot and is thereby held in the retaining frame.

4. The retaining frame as claimed in claim 1, wherein the retaining frame is made of a metal material.

5. The retaining frame as claimed in claim 1, wherein the retaining frame has at least one transfer lug which is provided for electrical contact with a retaining frame of a mating connector.

6. The retaining frame as claimed in claim 5, wherein the transfer lug extends in a plug-in direction.

7. The retaining frame as claimed in claim 5, wherein the retaining frame has two transfer lugs which are arranged diagonally opposite each other on the retaining frame.

8. The retaining frame as claimed in claim 1, wherein the retaining frame has a PE connection.

9. The retaining frame as claimed in claim 8 wherein the PE connection is designed as a screw connection and/or as a crimp connection and/or as a conductor welded to the retaining frame and/or as a conductor tab stamped into the retaining frame.

10. A system comprising:
a connector housing;
a retaining frame including a locking device with which the retaining frame can be locked in the connector housing, or wherein the retaining frame is at least partially enclosed by material of the connector housing and is therefore an integral part of the connector housing; and
at least two connector modules received in the retaining frame.

11. The system as claimed in claim 10, wherein each connector module consists of two independent functional units fixed to each other.
